(19) United States
(12) Patent Application Publication
(10) Pub. No.: US 2010/0262671 A1
(43) Pub. Date: Oct. 14, 2010

(54) Delay Parameter Testing for Multiple-Device Master-slave Configuration Using a Single-Device Testing System

(76) Inventors: Si Ruo Chen, Wuhan (CN); Jin Song Liu, Shanghai (CN); Tao Wang, Shanghai (CN)

Correspondence Address: Ryan, Mason & Lewis, LLP, 90 Forest Avenue, Locust Valley, NY, 11560, US

(21) Appl. No.: 12/423,276

(22) Filed: Apr. 14, 2009

(51) Int. Cl. G06F 15/16; G06F 11/28

(52) U.S. Cl. 709/208; 714/37; 714/E11.178

(57) ABSTRACT

Devices to be arranged in a master-slave configuration are individually tested using a testing system that ensures that the devices will satisfy an interconnection requirement of that configuration. The testing system configures a first device into one of a master mode of operation and a slave mode of operation, and adjusts frame starting positions of respective traffic flows associated with the configured mode until measured delay parameters of that mode substantially match corresponding ones of a selected set of prospective delay parameters. If the traffic flows of the one configured mode as adjusted are substantially error free, the first device is configured into the other mode, and frame starting positions of respective traffic flows associated with the other configured mode of the first device are adjusted until measured delay parameters of that mode substantially match corresponding ones of the selected set of prospective delay parameters. If the traffic flows of the other configured mode as adjusted are substantially error free, the first device is identified as satisfying the interconnection requirement.

### FIELD OF THE INVENTION

The present invention relates generally to testing of devices used in network-based communication systems, and more particularly to testing of mappers or other devices that are to be arranged in a master-slave configuration in such a communication system.

### BACKGROUND OF THE INVENTION

Conventional network-based communication systems include systems configured to operate in accordance with well-known synchronous transport standards, such as the synchronous optical network (SONET) and synchronous digital hierarchy (SDH) standards.

The SONET standard was developed by the Exchange Carriers Standards Association (ECSA) for the American National Standards Institute (ANSI), and is described in the document ANSI T1.105-1988, entitled “American National Standard for Telecommunications—Digital Hierarchy Optical Interface Rates and Formats Specification” (September 1988), which is incorporated by reference herein. SDH is a corresponding standard developed by the International Telecommunication Union (ITU), set forth in ITU standards documents G.707 and G.708, which are incorporated by reference herein.

The basic unit of transmission in the SONET standard is referred to as a synchronous transport signal level-1 (STS-1). It has a serial transmission rate of 51.84 Megabits per second (Mbps).

Synchronous transport signals at higher levels may be concatenated or channelized. For example, an intermediate unit of transmission in the SONET standard is referred to as synchronous transport signal level-3, concatenated (STS-3c). It has a serial transmission rate of 155.52 Mbps. The corresponding unit in the SDH standard is referred to as STM-1. In a concatenated synchronous transport signal, the entire payload is available as a single channel. A channelized signal, by way of contrast, is divided into multiple channels each having a fixed rate. For example, the channelized counterpart to the concatenated STS-3c signal is denoted STS-3. STS-3 is a channelized signal that comprises three separate STS-1 signals each at 51.84 Mbps.

A given STS-3c or STM-1 signal is organized in frames having a duration of 125 microseconds, each of which may be viewed as comprising nine rows by 270 columns of bytes, for a total frame capacity of 2,430 bytes per frame. The first nine bytes of each row are overhead, while the remaining 261 bytes of each row are payload. The overhead includes transport overhead (TOH) and path overhead (POH). The TOH includes section overhead (SOH), pointer information, and line overhead (LOH). Additional details regarding signal and frame formats can be found in the above-cited documents.

In conventional SONET or SDH network-based communication systems, synchronous transport signals like STS-3c or STM-1 are mapped to or from corresponding higher-rate optical signals such as a SONET OC-12 signal or an SDH STM-4 signal. An OC-12 optical signal carries four STS-3c signals, and thus has a rate of 622.08 Mbps. The SDH counterpart to the OC-12 signal is the STM-4 signal, which carries four STM-1 signals, and thus also has a rate of 622.08 Mbps. The mapping of these and other synchronous transport signals to or from higher-rate optical signals generally occurs in a physical layer device commonly referred to as a mapper, which may be used to implement an add-drop multiplexer (ADM) or other node of a SONET or SDH communication system.

Such a mapper typically interacts with a link layer processor. A link layer processor is one example of what is more generally referred to herein as a link layer device, where the term “link layer” generally denotes a switching function layer. Another example of a link layer device is a field programmable gate array (FPGA). These and other link layer devices can be used to implement processing associated with various packet-based protocols, such as Internet Protocol (IP) and Asynchronous Transfer Mode (ATM), as well as other protocols, such as Fiber Distributed Data Interface (FDDI).

A mapper is often implemented in the form of an integrated circuit, also referred to herein as a “chip.” In a given physical layer device, multiple mappers may be arranged in a master-slave configuration, with one of the mappers operating as a master and a number of other mappers operating as slaves. Such a configuration must be tested to ensure that it meets specified requirements such as maximum delay differences between frame starting positions of the various inter-device traffic flows and pulses of a frame synchronization signal sent from a master to a slave. However, it can be very difficult to implement such testing using conventional techniques. This is due in part to the fact that the mappers typically have gate counts that may be on the order of ten million gates or more. The complexity of the mappers makes it difficult to determine and test an appropriate set of delay parameters for achieving frame synchronization in a particular master-slave configuration. For example, most simulation environments are unable to accommodate multiple instances of the mapper. Also, a typical testing system designed to test only a single mapper at a time is generally unable to measure certain internal signals that influence the selection of appropriate delay parameters. A conventional approach is therefore to construct a separate multiple-device testing system that simultaneously incorporates all of the master and slave devices. This involves substantial additional time and expense beyond that required for device level testing of a single mapper.

Accordingly, a need exists for an improved approach to testing of multiple mappers or other physical layer devices that are to be arranged in a master-slave configuration in a synchronous transport communication system.

### SUMMARY OF THE INVENTION

Illustrative embodiments of the present invention overcome the above-noted drawbacks of conventional practice by providing techniques for testing of multiple mappers or other physical layer devices that are to be incorporated into a synchronous transport communication system, such as a SONET or SDH system.

In accordance with an aspect of the invention, multiple mapper integrated circuits or other devices to be arranged in a master-slave configuration are individually tested using a single-device testing system that ensures that the devices, when eventually arranged in the master-slave configuration, will satisfy a synchronization requirement or other interconnection requirement of that configuration. The testing system comprises traffic generation circuitry configured to generate traffic flows for application to respective inputs of a first device, delay circuitry configured to provide selectable delays to respective ones of the input traffic flows, and traffic checking circuitry configured to determine if output traffic flows received from respective outputs of the first device are substantially error free. The testing system further comprises controller circuitry configured to switch the first device between master and slave modes of operation, to control the delay circuitry to adjust frame starting positions of respective ones of the input traffic flows, and to control the first device to adjust frame starting positions of respective ones of the output traffic flows. Also included in the testing system is monitor circuitry configured to determine sets of measured delay parameters for the respective master and slave modes of operation.

In testing the first device, the controller circuitry of the testing system configures that device into one of a master mode of operation and a slave mode of operation, and adjusts frame starting positions of respective traffic flows associated with the configured mode until measured delay parameters of that mode substantially match corresponding ones of a selected set of prospective delay parameters. If the traffic checking circuitry determines that the traffic flows of the one configured mode as adjusted are substantially error free, the controller circuitry configures the first device into the other mode, and adjusts frame starting positions of respective traffic flows associated with the other configured mode of the first device until measured delay parameters of that mode substantially match corresponding ones of the selected set of prospective delay parameters. If the traffic checking circuitry determines that the traffic flows of the other configured mode as adjusted are substantially error free, the first device is identified as satisfying the requirement for interconnection with the one or more other devices in the master-slave configuration, and the selected set of prospective delay parameters is identified as an acceptable set of delay parameters for use with the first device in the master-slave configuration.

The testing may be repeated for other sets of prospective delay parameters, to determine if such other sets of prospective delay parameters should also be identified as acceptable for use with the first device in the master-slave configuration.

The testing may also be repeated for each of one or more other devices to be arranged in the master-slave configuration, using at least one selected set of prospective delay parameters that is identified as acceptable for use with the first device in the master-slave configuration.

The first device and the one or more other devices may comprise respective SONET/SDH mappers. The master-slave configuration may comprise, for example, the first device configured as a master mapper and two or more other devices configured as slave mappers.

Illustrative embodiments of the invention as described herein provide a number of significant advantages over the conventional techniques previously described. For example, these embodiments allow the determination and testing of an appropriate set of delay parameters for achieving frame synchronization in a particular master-slave configuration, without the need for a separate multiple-device testing system that simultaneously incorporates all of the master and slave devices. Instead, the delay parameters for the master-slave configuration can be determined and verified in an efficient manner using a modified version of a testing system that tests only a single mapper at a time, and thus in less time and at lower cost than is currently possible using conventional approaches.

### BRIEF DESCRIPTION OF THE DRAWINGS

FIG. 1 is a block diagram of one possible implementation of a network-based communication system comprising multiple mappers arranged in a master-slave configuration.

FIG. 2 is a more detailed view of a portion of the FIG. 1 system, showing an exemplary master-slave configuration of the multiple mappers.

FIG. 3 is a timing diagram illustrating exemplary delay parameters of the master-slave configuration shown in FIG. 2.

FIG. 4 is a block diagram of a testing system in accordance with an illustrative embodiment of the invention for determining a set of acceptable delay parameters for the master-slave configuration shown in FIG. 2.

FIG. 5 is a flow diagram of a testing process implemented in the testing system of FIG. 4.

FIG. 6 is a block diagram of a testing system in accordance with another illustrative embodiment of the invention.

### DETAILED DESCRIPTION OF THE INVENTION

The invention will be illustrated herein in conjunction with exemplary testing systems for testing mappers that are to be arranged in a master-slave configuration in a network-based communication system. It should be understood, however, that the invention is more generally applicable to any testing system in which it is desirable to provide improved efficiency and accuracy in testing of devices that are to be arranged in a master-slave configuration.

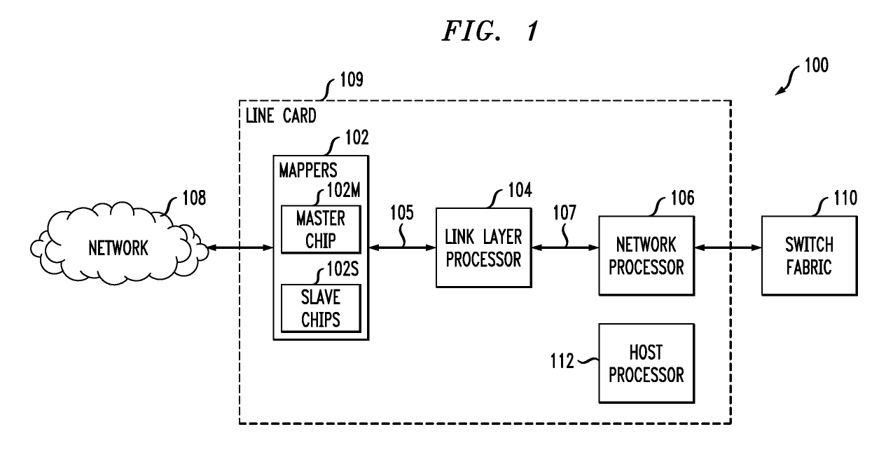

FIG. 1 shows a network-based communication system 100 that includes multiple mappers 102 arranged in a master-slave configuration. The mappers 102 are coupled to a link layer processor 104 via an interface 105. The mappers 102 are examples of physical layer devices suitable for providing access termination and aggregation for multiple services. One or more additional physical layer devices may be utilized in conjunction with the mappers 102, but such devices are not explicitly shown in the figure for clarity and simplicity of illustration. The link layer processor 104 is also coupled to a network processor 106, via an interface 107. The mappers 102 in this embodiment are coupled to a network 108. Examples of other types of physical layer devices that may be incorporated into the system 100 include optical transceivers for interfacing the mappers with an optical transmission medium of the network 108.

The link layer processor 104 is an example of what is more generally referred to herein as a “link layer device.” Such a device is intended to be broadly construed to encompass any type of processor which performs processing operations associated with a link layer of a network-based system. The term “physical layer device” as used herein is intended to encompass a device which provides an interface between a link layer device and a physical transmission medium of a network-based system.

In the FIG. 1 system, the mappers 102 are arranged in a master-slave configuration that includes at least one master mapper 102M and a plurality of slave mappers 102S. The designation of a particular one of the devices as a master and others as slaves is arbitrary, as in the illustrative embodiments any of the devices may be configured to operate as master or slave. However, in a given typical mode of operation one of the devices is designated the master and the others are designated as slaves. Other embodiments may include only a single slave mapper, rather than multiple slave mappers.

The mappers 102 perform signal mapping functions on SONET/SDH signals of a type generally known in the art. For example, network 108 may comprise routers, switches or other network elements of a SONET/SDH network operating as described in the above-cited SONET/SDH standards documents. It should be noted that the term “SONET/SDH” as used herein refers to SONET and/or SDH. The mappers 102 may provide an interface between such SONET/SDH network elements and other system elements, such as plesiochronous digital hierarchy (PDH) elements that process DS1/E1 and/or DS3/E3 signals.

The mappers 102 and link layer processor 104 may include additional functionality of a conventional type. Such additional functionality, being well known to those skilled in the art, will not be described in detail herein, but may include functionality associated with known mappers, such as the LSI Hypermapper™, Ultramapper™ and Supermapper™ devices, and known link layer devices, such as the LSI Link Layer Processor. These LSI devices are commercially available from LSI Corporation of Allentown, Pa., U.S.A. The network processor 106 may comprise, for example, a conventional network processor such as an LSI Advanced PayloadPlus® network processor in the APP300, APP500 or APP650 product family, also commercially available from LSI Corporation.

Additional details regarding conventional aspects of a SONET/SDH mapper can be found in, for example, TMXF84622 Ultramapper™ 622/155 Mbits/s SONET/SDH x DS3/E3/DS2/DS1/E1/DS0, Ultramapper™ Resource Document, Jun. 6, 2002, which is incorporated by reference herein.

The mappers 102, link layer processor 104, and network processor 106 in this illustrative embodiment are installed on a line card 109 of the system 100. The line card 109 is coupled between network 108 and a switch fabric 110 of the system 100 as shown. The link layer processor 104 and network processor 106 are configured to communicate packets, cells or other protocol data units (PDUs) between the network 108 and the switch fabric 110 which controls switching of PDU data. As indicated previously, the mappers 102 serve to interface the link layer processor 104 to physical transmission media of the network 108, which may comprise optical fiber links or any other type of transmission media.

Also installed on the line card 109 is a host processor 112. This processor is used to configure and control one or more of the other processing elements of the line card, such as the mappers 102, link layer processor 104 and network processor 106. As a more particular example, a given such host processor utilized to configure and control both the mappers 102 and the link layer processor 104 is referred to herein as a microprocessor unit (MPU). Portions of the host processor functionality may be incorporated into one or more of elements 102, 104 or 106 in alternative embodiments of the invention.

Various elements of the system 100 may be implemented, by way of example and without limitation, utilizing a microprocessor, central processing unit (CPU), digital signal processor (DSP), application-specific integrated circuit (ASIC), FPGA, or other type of data processing device, as well as portions or combinations of these and other devices.

It should be noted that the line card configuration shown in FIG. 1 is merely one example of a possible system configuration. Other embodiments can be implemented using a wide variety of other types of structural arrangements that do not involve line cards. The elements 102, 104, 106, 109, 110 and 112 in this example may be viewed as being part of a particular node of network 108 that operates in accordance with the SONET/SDH standards. Other nodes of the network 108 may of course be configured in a similar manner.

The interface 105 between the mappers 102 and the link layer processor 104 may comprise a conventional interface over which signals are transmitted from mappers to a link layer processor, and over which signals are received by mappers from a link layer processor.

The mappers 102 may be equipped with payload extraction and insertion functionality, such that SONET/SDH payloads can be communicated between the mappers and the link layer device. See U.S. patent application Ser. No. 11/839,971, filed Aug. 16, 2007 and entitled “Synchronous Transport Signal Mapper with Payload Extraction and Insertion Functionality,” which is commonly assigned herewith and incorporated by reference herein.

The mappers 102 may also or alternatively be configured to support 1+1 protection switching. For example, the mappers may comprise a working device and a protection device, with in-band communication of alarm status information or other types of information between the protection device and the working device. Such arrangements are described in U.S. patent application Ser. No. 11/935,533, filed Nov. 6, 2007 and entitled “In-Band Communication of Alarm Status Information in a Synchronous Transport Communication System,” which is commonly assigned herewith and incorporated by reference herein.

The interface 107 between the link layer processor 104 and the network processor 106 may be, for example, a conventional interface such as a SPI-3 interface as described in Implementation Agreement OTF-SP13-01.0, “System Packet Interface Level 3 (SPI-3): OC-48 System Interface for Physical and Link Layer Devices,” Optical Internetworking Forum, 2001, which is incorporated by reference herein. Other types of known interfaces, such as POS-2, may also be used.

Although the link layer processor 104 and network processor 106 are shown as separate elements in this illustrative embodiment, other embodiments may combine the functionality of the link layer processor and the network processor into a single link layer device. The general term “link layer device” as used herein is thus intended to encompass devices which incorporate at least a portion of the functionality commonly associated with a network processor.

For example, a given link layer device may be configured to provide flow control, traffic shaping and other functions. It may include an internal memory, as well as an interface to an external memory. Such memory elements may be utilized for implementing PDU buffer memory, queuing and dispatch buffer memory, etc. The link layer device may further include one or more memory controllers, as well as appropriate interface circuitry for interfacing with the mappers 102 or other physical layer device(s), the switch fabric 110, and other external devices, such as the host processor 112, which may be configured to communicate with the link layer device over a standard bus architecture, e.g., a peripheral component interconnect (PCI) bus. The link layer device may also include a scheduler, queuing and dispatch logic, as well as other conventional elements not explicitly shown in the figure. The operation of these and other conventional elements, being well understood by those skilled in the art, is not described in detail herein.

Numerous alternative interfacing arrangements are possible. It is also possible that, in other embodiments, a given link layer device may be combined with one or more physical layer devices into a single device. Thus the mappers 102 and any associated physical layer device(s) need not be physically separate from the link layer processor 104 as in the FIG. 1 embodiment, but such elements could instead be combined into a single integrated circuit or other type of processing device.

It may be assumed with reference to the system 100 of FIG. 1 that an “ingress” direction refers to a direction of data transfer from the network 108 to the switch fabric 110. Similarly, it may be assumed that an “egress” direction refers to a direction of data transfer from the switch fabric 110 to the network 108. It should be understood that these and other assumptions made herein are for clarity and simplicity of description only, and should not be construed as limitations of the invention. The terms “ingress” and “egress” thus do not refer to particular fixed directions, but instead may be viewed as arbitrary input and output data flow directions in a particular system implementation.

It should also be noted that the particular arrangement of system elements shown in FIG. 1 is by way of illustrative example only. More particularly, devices tested using the techniques disclosed herein can be implemented in any type of communication system which utilizes such devices in a master-slave configuration. The system 100 may include other elements in addition to or in place of those specifically shown, including one or more elements of a type commonly found in a conventional implementation of such a system.

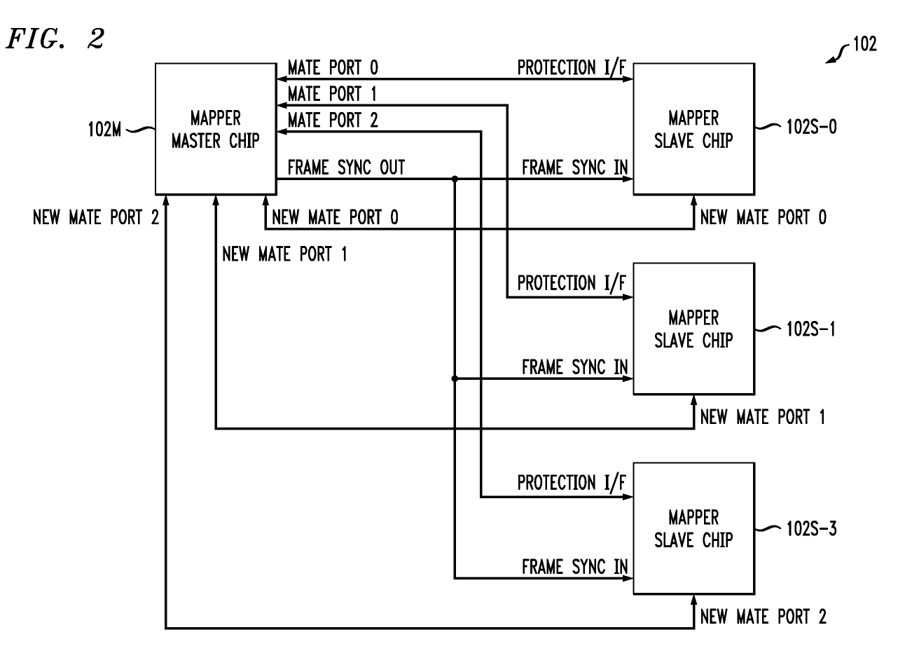

FIG. 2 shows a more detailed view of an exemplary master-slave configuration of the mappers 102 in one embodiment. Each mapper in this embodiment is assumed to be implemented as a separate integrated circuit or “chip.” Thus, the mappers 102 comprise a master chip 102M and a plurality of slave chips 102S, more specifically three slave chips individually denoted as 102S-1, 102S-2 and 102S-3. Master chips may also be referred to herein as master devices or simply “masters.” Similarly, slave chips may also be referred to herein as slave devices or simply “slaves.”

Although the master-slave configuration in the FIG. 2 embodiment includes one master and three slaves, alternative embodiments of the invention may include different numbers and arrangements of such devices. For example, a given embodiment may include one master and one slave, one master and two slaves, etc.

Traffic flows between the master 102M and the slaves 102S in FIG. 2 include a first set of traffic flows between Mate Port 0, Mate Port 1 and Mate Port 2 of the master and respective line protection interfaces (I/F) of the slaves 102S, and a second set of traffic flows between New Mate Port 0, New Mate Port 1 and New Mate Port 2 of the master and corresponding ports of the respective slaves 102S. A frame sync output of the master 102M is coupled to corresponding frame sync inputs of the respective slaves 102S.

As mentioned previously herein, in testing a given implementation of multiple mappers arranged in a master-slave configuration, it is important to determine and test an appropriate set of delay parameters for achieving frame synchronization in that configuration. The delay parameters should be selected such that the master-slave configuration meets specified requirements such as, for example, maximum specified delay differences between a pulse of a frame synchronization signal and frame starting positions of the various traffic flows associated with the interconnection of the master 102M and the slaves 102S. Illustrative embodiments of the invention allow such delay parameters to be determined and tested in a particularly efficient and accurate manner without the need to collectively implement all of the interconnected mappers in a separate multiple-device testing system.

In the master-slave configuration of FIG. 2, each of the traffic flows in the two sets of traffic flows between the master 102M and the slaves 102S is a bidirectional traffic flow and is SONET/SDH frame based, with a defined frame structure. A frame sync pulse is used to indicate the starting position in each frame.

As indicated previously, each of the mappers 102 in the present embodiment is assumed to be controllable between operation as a master and operation as a slave. For a given mapper operating in the master mode, the frame sync is an output, while for a given mapper operating in the slave mode, it is an input. The present invention, however, does not require that each mapper be controllable in this manner.

The above-noted specified requirements include maximum delay differences between frame starting positions of the various traffic flows, as indicated by the respective Frame Sync pulses. This is generally due to limitations in buffer size and chip latency within the mappers.

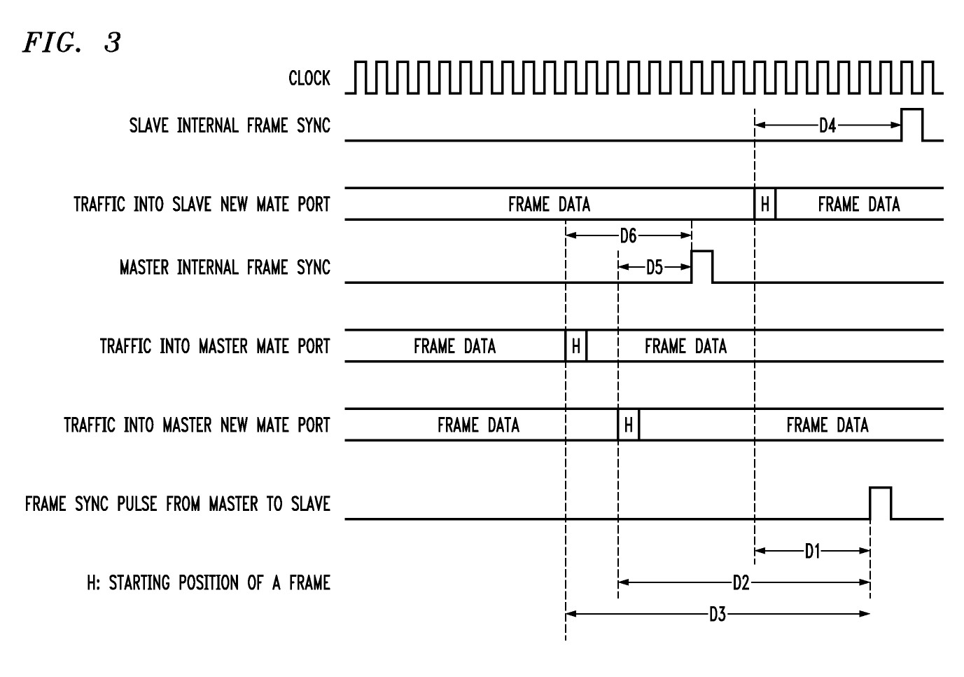

FIG. 3 shows a timing diagram for the master-slave configuration of FIG. 2. The diagram illustrates the timing relationships between a clock signal, an internal frame sync signal of the master 102M, an internal frame sync signal of a given one of the slaves 102S, a frame sync signal delivered from the master to the slaves, traffic into a new mate port of the given slave, traffic into a mate port of the master, and traffic into a new mate port of the master. A frame header (H) indicates the starting position of a frame in each traffic flow.

The internal frame sync signals of the master and slave are internal signals that are not visible outside of the respective chips. That is, such signals cannot be observed at external pins of the packaged integrated circuits.

The timing diagram of FIG. 3 shows a set of delay parameters D1, D2 and D3 measured in the master-slave configuration of FIG. 2 relative to the start of a pulse of the frame sync signal delivered from the master 102M to the given slave 102S. More particularly, D1 is the delay difference between a rising edge of the frame sync pulse and the frame starting position of the traffic into the slave new mate port, D2 is the delay difference between the rising edge of the frame sync pulse and the frame starting position of the traffic into the master new mate port, and D3 is the delay difference between the rising edge of the frame sync pulse and the frame starting position of the line protection traffic into the master mate port.

As the associated traffic and frame sync signals are observable externally to the mappers, the delay differences D1, D2 and D3 can be measured externally.

It should be noted that the delay differences D1, D2 and D3 are defined differently for different contexts herein, as will be explained in greater detail below.

The timing diagram of FIG. 3 also shows a set of delay parameters D4, D5 and D6 measured relative to the start of a pulse of the master or slave internal frame sync signal. More particularly, D4 is the delay difference between a rising edge of the slave internal frame sync pulse and the frame starting position of the traffic into the slave new mate port, D5 is the delay difference between a rising edge of the master internal frame sync pulse and the frame starting position of the traffic into the master new mate port, and D6 is the delay difference between the rising edge of the master internal frame sync pulse and the frame starting position of the line protection traffic into the master mate port.

As the internal frame sync signals of the master and slave are internal signals that cannot be observed at external pins of the packaged integrated circuits, the delay differences D4, D5 and D6 cannot be measured externally.

The maximum internal delay differences D4, D5 and D6 that can be accommodated within a particular master-slave configuration are determined by factors such as the internal buffer size and chip latency of the master and slave chips. For example, limits on D4 are determined by the buffer size and chip latency of the slave 102S.

It is important to determine a configuration of the master and slave mappers that satisfies the maximum internal delay differences D4, D5 and D6, in order to ensure that frequency synchronization can be maintained. As noted above, the delay differences D1, D2 and D3 are observable externally to the mappers.

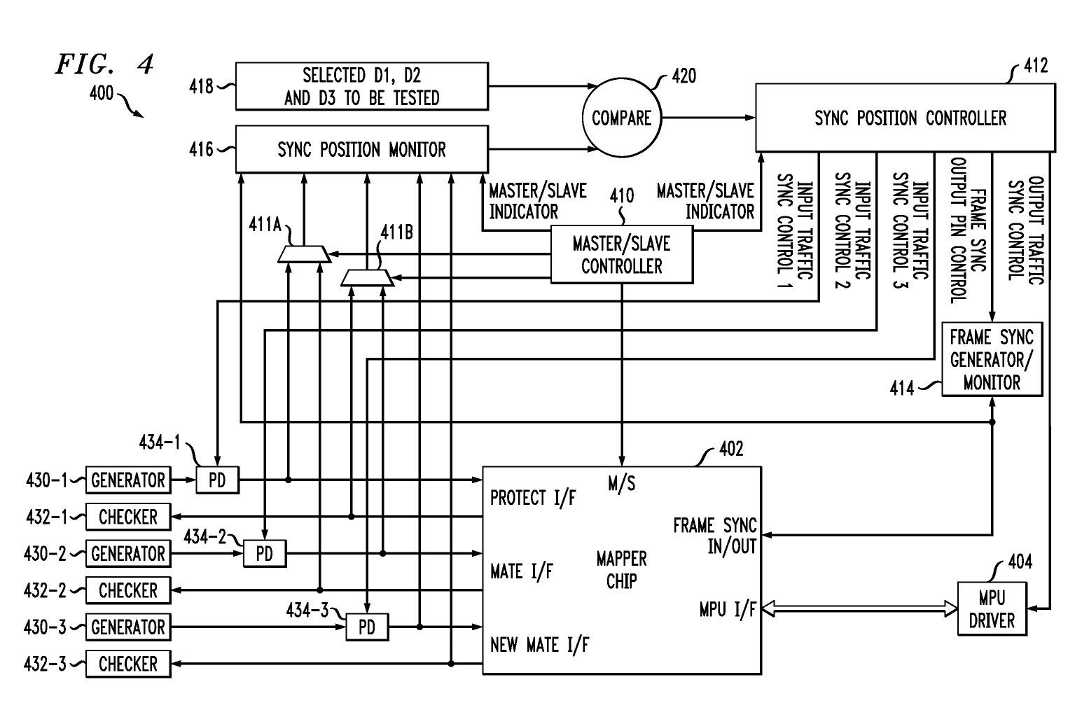

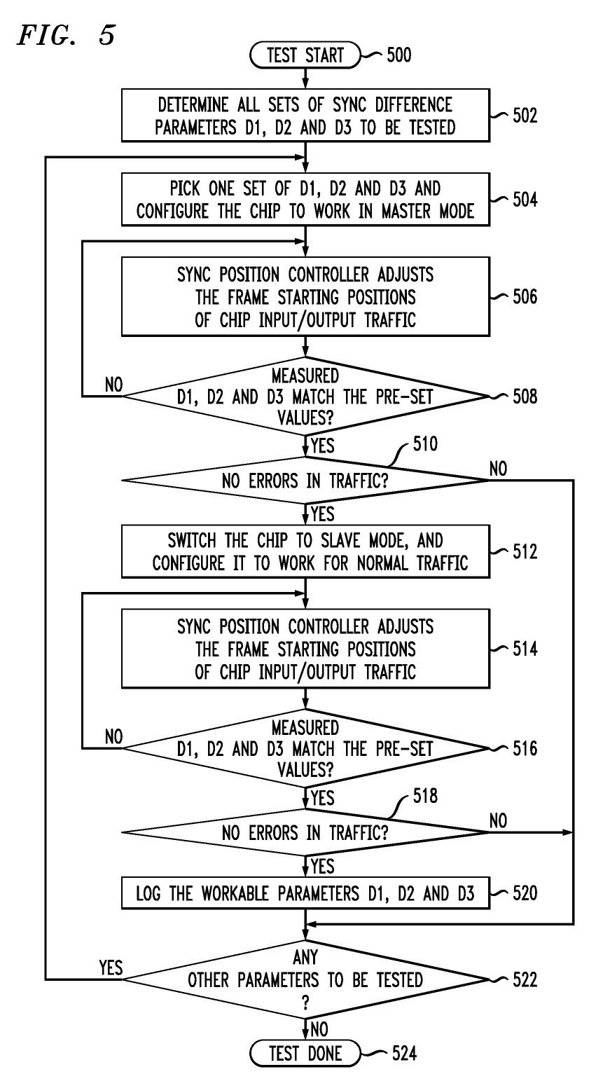

FIGS. 4 and 5 illustrate a testing system and a testing process for determining appropriate sets of delay parameters for use in the master-slave configuration of FIG. 2. As will become apparent, this testing system and process advantageously avoid the need for simultaneously testing the entire master-slave configuration, and are instead implemented in an arrangement which requires testing of only a single mapper at a time. In this illustrative embodiment, multi-chip interconnection requirements such as delay parameters D4, D5 and D6 are translated into equivalent checking criteria that are observable at the single device interface, in a manner that makes it unnecessary to implement multiple chip instances in the testing system. A feedback control mechanism comprising a measure-control loop is applied to ensure that a determined set of externally-observable delay parameters will allow the master-slave configuration to satisfy the appropriate synchronization requirements.

Referring now to FIG. 4, testing system 400 comprises a single device under test (DUT) which in this embodiment is a mapper chip 402 that may correspond to any one of the master 102M or slaves 102S of FIG. 2. The mapper chip 402 is assumed to be operable in either a master mode or a slave mode. It includes a frame sync interface, a line protection interface, a mate interface, a new mate interface and an MPU interface. The MPU interface is coupled to an MPU driver 404. The mapper chip 402 further includes a master/slave mode select port (M/S) which is used to control the chip operating mode.

The testing system 400 further comprises a generator 430, checker 432 and programmable delay component 434 for each of the line protection interface, mate interface and new mate interface of the mapper chip 402. The generator, checker and programmable delay components are more particularly denoted 430-1, 432-1 and 434-1 for the line protection interface, 430-2, 432-2 and 434-2 for the mate interface, and 430-3, 432-3 and 434-3 for the new mate interface. Other elements of the testing system 400 include a master/slave controller 410, 2-to-1 multiplexers 411A and 411B, a sync position controller 412, a frame sync generator/monitor 414, a sync position monitor 416, a delay parameter selector 418, and a comparison element 420.

The flow diagram of FIG. 5 illustrates an exemplary testing process implemented in the testing system 400 of FIG. 4. The testing process includes steps 500 through 524, and starts in step 500. In step 502, all of the sets of delay differences D1, D2 and D3 to be tested are determined. These parameters are also referred to herein as sync difference parameters, and may be viewed as an example of what are more generally referred to herein as “delay parameters.” In step 504, one of these sets of parameters is selected and loaded into element 418 of FIG. 4, and the mapper chip 402 is configured in its master mode of operation using the master/slave controller 410. The sync position controller 412 then adjusts the frame starting positions of the input and output traffic, as indicated in step 506. More specifically, the sync position controller adjusts the frame starting positions of the line protection input traffic, mate input traffic and new mate input traffic applied to the mapper chip 402 from the respective generators 430-1, 430-2 and 430-3 by supplying appropriate input traffic sync control signals to the respective programmable delay components 434-1, 434-2 and 434-3. The sync position controller adjusts the frame starting positions of output traffic for the line protection, mate and new mate interfaces by supplying an appropriate output traffic sync control signal to the MPU interface of the mapper chip 402 via the MPU driver 404. For example, this output traffic sync control signal from the sync position controller can configure registers in the mapper chip 402 that set internal programmable delays for the line protection output traffic, mate output traffic and new mate output traffic, respectively.

As the mapper chip 402 at this point in the process is in its master mode of operation, D1 is the delay difference between the frame sync output and the frame starting position of the new mate output traffic, D2 is the delay difference between the frame sync output and the frame starting position of new mate input traffic, and D3 is the delay difference between the frame sync output and the frame starting position of the line protection output traffic. The sync position monitor 416 measures the delay differences D1, D2 and D3, and a determination is made in step 508, using comparison element 420, as to whether or not those measured delay differences match the corresponding pre-set values stored in element 418. The “pre-set values” in the present embodiment are an example of what is more generally referred to herein as “a selected set of prospective delay parameters.” Other embodiments can use other types of difference parameters, or more generally, delay parameters.

If the measured D1, D2 and D3 values match the corresponding pre-set values, the process moves to step 510, and otherwise returns to step 506 for the sync position controller 412 to make a further adjustment in the frame starting positions of the chip input and output traffic. The sync position controller will thus continue adjusting the frame starting positions until a determination is made in step 508 that the measured values match the pre-set values.

In step 510, a determination is made as to whether or not the traffic has no errors or is otherwise substantially error free for the selected set of delay differences D1, D2 and D3. In this context, “substantially error free” is intended to encompass an error rate at or below an acceptable level, and thus should not be construed as requiring zero errors. If the traffic is not substantially error free, the selected set of parameters is not a workable set, and the process therefore moves to step 522 to determine if there are any other sets of parameters to be tested. If there is at least one additional set of parameters remaining to be tested, the process returns to step 504 to select a given such additional set for testing. Otherwise there is no workable set of parameters, and the test ends with a negative result in step 524.

If the traffic is determined in step 510 to be substantially error free, the process in step 512 switches the mapper chip 402 to its slave mode of operation using master/slave controller 410, configuring it to work for normal traffic. The sync position controller 412 then adjusts the frame starting positions of the input and output traffic, as indicated in step 514.

It should be noted that steps 514, 516 and 518 performed with the mapper chip 402 in its slave mode of operation are generally analogous to respective steps 506, 508 and 510 previously performed with the mapper chip in its master mode of operation.

As the mapper chip 402 at this point in the process is in its slave mode of operation, the definitions of the D1, D2 and D3 values are different than when the mapper chip was in its master mode of operation. More specifically, with the mapper chip in its slave mode of operation, D1 is the delay difference between the frame sync input and the frame starting position of the new mate input traffic, D2 is the delay difference between the frame sync input and the frame starting position of new mate output traffic, and D3 is the delay difference between the frame sync input and the frame starting position of the mate input traffic. The sync position monitor 416 measures these delay differences D1, D2 and D3, and a determination is made in step 516, using comparison element 420, as to whether or not those measured delay differences match the corresponding pre-set values stored in element 418.

If the measured D1, D2 and D3 values match the corresponding pre-set values, the process moves to step 518, and otherwise returns to step 514 for the sync position controller 412 to make a further adjustment in the frame starting positions of the chip input and output traffic. The sync position controller will thus continue adjusting the frame starting positions until a determination is made in step 516 that the measured values match the pre-set values.

In step 518, a determination is made as to whether or not the traffic has no errors or is otherwise substantially error free for the selected set of delay differences D1, D2 and D3. If the traffic is not substantially error free, the selected set of parameters is not a workable set, and the process therefore moves to step 522 to determine if there are any other sets of parameters to be tested. If there is at least one additional set of parameters remaining to be tested, the process returns to step 504 to select a given such additional set for testing. If the traffic is determined in step 518 to be substantially error free, the process in step 520 logs the selected set of parameters as a workable set for both master and slave modes of operation of the mapper chip 402. One or more additional sets of parameters may be tested if determined to be available in step 522, and otherwise the testing ends in step 524.

As indicated previously, if the test ends in step 524 without any workable set of parameters being found, it generally means that the mapper chip 402 cannot be connected in a master-slave configuration of the type shown in FIG. 2.

It should be understood that the particular process steps of FIG. 5 and the testing system configuration as shown in FIG. 4 may be varied in other embodiments. For example, those skilled in the art will appreciate that different types of testing system circuitry may be utilized to determine a particular set of workable delay parameters for a given master-slave configuration of a set of mapper chips or other physical layer devices.

Also, although the master mode of operation is tested first in the FIG. 5 process, followed by testing of the slave mode of operation, it is also possible to test the slave mode first, followed by testing of the master mode. Numerous other testing sequences may be used in alternative embodiments.

The illustrative embodiments of FIGS. 4 and 5 allow a given set of selected parameters to be tested for both master and slave modes of operation of a given DUT. Each of the master and slave mappers 102 of FIG. 2 may be separately tested as a single DUT in the manner described above. If each of the mappers is functional in both its master and slave modes with the same selected set of D1, D2 and D3 parameters, the mappers can be configured in the master-slave configuration of FIG. 2 without producing an excessive number of errors or otherwise violating synchronization requirements. This approach avoids the need for estimating or otherwise determining internal delay parameters such as the D4, D5 or D6 parameters previously described.

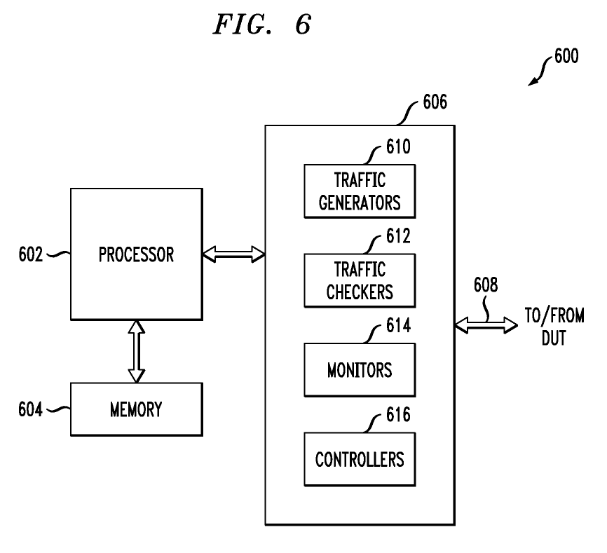

FIG. 6 shows a testing system 600 in accordance with another illustrative embodiment of the invention. In this embodiment, the testing system comprises a processor 602 coupled to a memory 604. Also included in the testing system is a set of testing circuitry 606 that communicates with a device under test via an interface 608. The testing circuitry 606 includes traffic generators 610, traffic checkers 612, monitors 614 and controllers 616, and may include additional or alternative elements not specifically shown, at least a portion of which are operated under control of the processor 602. The various elements of the testing circuitry 606 that are operated under the control of the processor 602 in this embodiment may incorporate elements similar to those illustrated in conjunction with the embodiment of FIG. 4.

The memory 604 may store selected sets of prospective delay parameters that are to be tested in the manner described in conjunction with FIG. 5. Also, the memory 604 may store program code that is executed by the processor to implement a particular testing process used in the system 600. The memory is an example of what is more generally referred to herein as a computer-readable medium or other type of computer program product having computer program code embodied therein, and may comprise, for example, electronic memory such as RAM or ROM, magnetic memory, optical memory, or other types of storage devices in any combination. The processor 602 may comprise a microprocessor, CPU, ASIC, FPGA or other type of processing device, as well as portions or combinations of such devices.

In other embodiments, portions of the testing circuitry 606, such as the controllers 616, may be implemented within the processor 602.

As noted previously, the illustrative embodiments avoid the need for a testing system that can simultaneously test multiple mappers in a master-slave configuration. A single-mapper testing system such as that shown in FIG. 4 or 6 can therefore accommodate interconnection testing of mappers having very high gate counts.

A testing system in accordance with the invention may be implemented in the form of one or more integrated circuit devices suitable for installation on a board or card of an otherwise conventional testing system.

In a given such integrated circuit implementation, identical die are typically formed in a repeated pattern on a surface of a semiconductor wafer. Each die includes at least a portion of testing system as described herein, and may include other structures or circuits. The individual die are cut or diced from the wafer, then packaged as an integrated circuit. One skilled in the art would know how to dice wafers and package die to produce integrated circuits. Integrated circuits so manufactured are considered part of this invention.

Again, it should be emphasized that the embodiments of the invention as described herein are intended to be illustrative only. For example, the invention can be implemented using a wide variety of other types of master-slave configurations, with different numbers of master and slave devices, than those previously described in conjunction with the illustrative embodiments.

It should also be understood that although the illustrative embodiments are described primarily in the SONET/SDH context using master-slave configurations having particular frame sync relationship requirements between master and slave devices, the disclosed techniques can be adapted in a straightforward manner for use in numerous other communication system applications involving interconnection of master and slave devices.

In addition, the particular arrangements of testing system circuitry and other elements as shown in FIGS. 4 and 6 may be varied in alternative embodiments. Also, the particular testing processes shown in FIG. 5 and described above are presented by way of example, and those skilled in the art will recognize that alternative steps may be used.

These and numerous other alternative embodiments within the scope of the following claims will be readily apparent to those skilled in the art.

What is claimed is:

1. A system for testing a first device to determine if the device satisfies at least one requirement for interconnection with one or more other devices in a master-slave configuration, the testing system comprising:
traffic generation circuitry configured to generate traffic flows for application to respective inputs of the first device;
delay circuitry configured to provide selectable delays to respective ones of the input traffic flows;
traffic checking circuitry configured to determine if output traffic flows received from respective outputs of the first device are substantially error free;
controller circuitry configured to switch the first device between master and slave modes of operation, to control the delay circuitry to adjust frame starting positions of respective ones of the input traffic flows, and to control the first device to adjust frame starting positions of respective ones of the output traffic flows; and
monitor circuitry configured to determine sets of measured delay parameters for the respective master and slave modes of operation;
wherein the controller circuitry configures the first device into one of the master mode of operation and the slave mode of operation, and adjusts frame starting positions of respective ones of the traffic flows associated with the one configured mode of the first device until measured delay parameters of that mode substantially match corresponding ones of a selected set of prospective delay parameters;
wherein if the traffic checking circuitry determines that the traffic flows of the one configured mode as adjusted are substantially error free, the controller circuitry configures the first device into the other of the master mode of operation and the slave mode of operation, and adjusts frame starting positions of respective traffic flows associated with the other configured mode of the first device until measured delay parameters of that mode substantially match corresponding ones of the selected set of prospective delay parameters; and
wherein if the traffic checking circuitry determines that the traffic flows of the other configured mode as adjusted are substantially error free, the first device is identified as satisfying the requirement for interconnection with the one or more other devices in the master-slave configuration, and the selected set of prospective delay parameters is identified as an acceptable set of delay parameters for use with the first device in the master-slave configuration.

2. The system of claim 1 wherein the first device and the one or more other devices comprise respective SONET/SDH mappers.

3. The system of claim 1 wherein the master-slave configuration comprises the first device configured as a master device and at least two other devices configured as slave devices.

4. The system of claim 1 wherein the controller circuitry further comprises:
a master/slave controller having a first control output adapted for connection to a first control input of the first device;
a sync position controller having a first control input adapted for connection to a second control output of the master/slave controller, a plurality of control outputs adapted for connection to respective control inputs of the delay circuitry, and at least one control output adapted for connection to a second control input of the first device;
a sync position monitor having a first control input adapted for connection to a third control output of the master/slave controller, and a plurality of traffic inputs adapted to receive respective ones of the traffic flows; and
comparison circuitry configured to receive the sets of measured delay parameters from the sync position monitor and to compare said sets with the selected set of prospective delay parameters.

5. The system of claim 4 further comprising:
a first multiplexer having traffic inputs coupled to respective ones of a first pair of input and output traffic lines associated with the first device, a traffic output coupled to a first one of the plurality of traffic inputs of the sync position monitor, and a control input coupled to a fourth control output of the master/slave controller; and
a second multiplexer having traffic inputs coupled to respective ones of a second pair of input and output traffic lines associated with the first device, a traffic output coupled to a second one of the plurality of traffic inputs of the sync position monitor, and a control input coupled to a fifth control output of the master/slave controller.

6. The system of claim 4 further comprising a frame sync unit operative to monitor a frame sync signal generated by the first device in the master mode of operation and to generate a frame sync signal for application to the first device in the slave mode of operation.

7. The system of claim 6 wherein the frame sync unit has a control input coupled to a frame sync control output of the sync position controller for receiving a frame sync control signal when the first device is in the slave mode of operation and further wherein the sync position monitor has a frame sync input adapted to receive the frame sync signal generated by the first device in the master mode of operation and to receive the frame sync signal generated by the frame sync unit in the slave mode of operation.

8. The system of claim 1 wherein the measured delay parameters of the master mode of operation comprise a first delay difference between a frame sync output of the first device and a frame starting position of output traffic of a first traffic interface of the first device, a second delay difference between the frame sync output and a frame starting position of input traffic of the first traffic interface of the first device, and a third delay difference between the frame sync output and a frame starting position of output traffic of a second traffic interface of the first device.

9. The system of claim 8 wherein the measured delay parameters of the slave mode of operation comprise a first delay difference between a frame sync input of the first device and a frame starting position of input traffic of the first traffic interface of the first device, a second delay difference between the frame sync input and a frame starting position of output traffic of the first traffic interface of the first device, and a third delay difference between the frame sync input and a frame starting position of input traffic of a third traffic interface of the first device.

10. The system of claim 8 wherein the first traffic interface of the first device comprises a new mate interface of a mapper integrated circuit.

11. The system of claim 8 wherein the second traffic interface of the first device comprises a line protection interface of a mapper integrated circuit.

12. The system of claim 9 wherein the third traffic interface of the first device comprises a mate interface of a mapper integrated circuit.

13. The system of claim 1 further comprising:
a processor; and
a memory coupled to the processor and configured to store the selected set of prospective delay parameters;
wherein at least a portion of the traffic generation circuitry, the delay circuitry, the traffic checking circuitry, the controller circuitry and the monitor circuitry is operated under control of the processor.

14. The system of claim 1 further comprising a processor that implements at least a portion of the traffic generation circuitry, the delay circuitry, the traffic checking circuitry, the controller circuitry and the monitor circuitry.

15. A method for testing a first device to determine if the device satisfies at least one requirement for interconnection with one or more other devices in a master-slave configuration, the method comprising the steps of:
inserting the first device into a testing system;
configuring the first device into one of a master mode of operation and a slave mode of operation;
adjusting frame starting positions of respective traffic flows associated with the one configured mode of the first device until measured delay parameters of that mode substantially match corresponding ones of a selected set of prospective delay parameters;
determining if traffic flows of the one configured mode as adjusted are substantially error free;
if the traffic flows of the one configured mode as adjusted are substantially error free, configuring the first device into the other of the master mode of operation and the slave mode of operation;
adjusting frame starting positions of respective traffic flows associated with the other configured mode of the first device until measured delay parameters of that mode substantially match corresponding ones of the selected set of prospective delay parameters;
determining if the traffic flows of the other configured mode as adjusted are substantially error free;
if the traffic flows of the other configured mode as adjusted are substantially error free, identifying the first device as satisfying the requirement for interconnection with the one or more other devices in the master-slave configuration, and identifying the selected set of prospective delay parameters as an acceptable set of delay parameters for use with the first device in the master-slave configuration.

16. The method of claim 15 wherein the master-slave configuration comprises the first device configured as a master device and at least two other devices configured as slave devices.

17. The method of claim 15 further comprising the steps of:
selecting another set of prospective delay parameters; and
repeating at least a portion of the configuring, adjusting and determining steps to determine if the other selected set of prospective delay parameters should be identified as acceptable for use with the first device in the master-slave configuration.

18. The method of claim 17 wherein the selecting and repeating steps are repeated for any remaining sets of prospective delay parameters in a plurality of sets of delay parameters.

19. The method of claim 15 further comprising the step of repeating at least a portion of the configuring, adjusting and determining steps for each of the one or more other devices using the selected set of prospective delay parameters that is identified as acceptable for use with the first device in the master-slave configuration.

20. A computer program product having computer program code embodied therein for use in testing a first device to determine if the device satisfies at least one requirement for interconnection with one or more other devices in a master-slave configuration, wherein the computer program code when executed in a testing system causes the testing system to perform the steps of:
configuring the first device into one of a master mode of operation and a slave mode of operation;
adjusting frame starting positions of respective traffic flows associated with the one configured mode of the first device until measured delay parameters of that mode substantially match corresponding ones of a selected set of prospective delay parameters;
determining if traffic flows of the one configured mode as adjusted are substantially error free;
if the traffic flows of the one configured mode as adjusted are substantially error free, configuring the first device into the other of the master mode of operation and the slave mode of operation;
adjusting frame starting positions of respective traffic flows associated with the other configured mode of the first device until measured delay parameters of that mode substantially match corresponding ones of the selected set of prospective delay parameters;
determining if the traffic flows of the other configured mode as adjusted are substantially error free;
if the traffic flows of the other configured mode as adjusted are substantially error free, identifying the first device as satisfying the requirement for interconnection with the one or more other devices in the master-slave configuration, and identifying the selected set of prospective delay parameters as an acceptable set of delay parameters for use with the first device in the master-slave configuration.
